(19) United States
(12) Patent Application Publication
(10) Pub. No.: US 2025/0030492 A1
(43) Pub. Date: Jan. 23, 2025

(54) ARTICLE OF PERSONAL PROTECTIVE EQUIPMENT, COMMUNICATION SYSTEM, AND COMPUTER-IMPLEMENTED METHOD OF COMMUNICATION

(71) Applicant: 3M INNOVATIVE PROPERTIES COMPANY, St. Paul, MN (US)

(72) Inventors: Adam R. Krause, Charlotte, NC (US); Darin K. Thompson, Huntersville, NC (US); William B. Howell, Pineville, NC (US)

(21) Appl. No.: 18/714,755

(22) PCT Filed: Dec. 2, 2022
(86) PCT No.: PCT/IB2022/061705

§ 371 Date: May 30, 2024

Related U.S. Application Data
(60) Provisional application No. 63/265,068, filed on Dec. 7, 2021.

(51) Int. Cl. H04B 17/318; H04W 4/90; H04W 72/02

(52) U.S. Cl. CPC H04B 17/318; H04W 4/90; H04W 72/02

(57) ABSTRACT

An article of personal protective equipment (PPE) includes a plurality of communication circuits corresponding to a plurality of communication channels, and a controller communicably coupled to the communication circuits. The controller is configured to receive data signals. The controller is further configured to determine a signal strength of the communication channels and generate available connections data for the communication channels. The controller is further configured to determine corresponding data types of the data signals. The controller is further configured to determine available communication channels, select at least one available communication channel based on at least the corresponding data types of the data signals, and select at least one communication circuit corresponding to the at least one available communication channel, such that the at least one communication circuit receives the data signals and transmits the data signals to one or more external devices over the at least one available communication channel.

### TECHNICAL FIELD

The present disclosure relates to an article of personal protective equipment (PPE) and a communication system including the article of PPE. The present disclosure further relates to a computer-implemented method of communication.

### BACKGROUND

Articles of personal protective equipment (PPE) may be used by personnel working in hazardous environments. In such hazardous environments, a communication system may be required to communicate information and telemetry data with other personnel (e.g., emergency responders) or a central base station in real-time.

### SUMMARY

In a first aspect, the present disclosure provides an article of personal protective equipment (PPE). The article of PPE includes a plurality of communication circuits corresponding to a plurality of communication channels. The article of PPE further includes a memory configured to store a plurality of data types. The article of PPE further includes a controller communicably coupled to the plurality of communication circuits and the memory. The controller is configured to receive one or more data signals. The one or more data signals have corresponding data types from the plurality of data types. The controller is further configured to determine a signal strength of each of the plurality of communication channels. The controller is further configured to generate available connections data for the plurality of communication channels based on the signal strength of each of the plurality of communication channels. The controller is further configured to determine the corresponding data types of the one or more data signals by comparing the one or more data signals with the plurality of data types stored in the memory. The controller is further configured to determine one or more available communication channels from the plurality of communication channels based on the available connections data. The one or more available communication channels are available to transmit the one or more data signals. The controller is further configured to select at least one available communication channel from the one or more available communication channels based on at least the corresponding data types of the one or more data signals. The controller is further configured to select at least one communication circuit from the plurality of communication circuits corresponding to the at least one available communication channel, such that the at least one communication circuit receives the one or more data signals and transmits the one or more data signals to one or more external devices over the at least one available communication channel.

In a second aspect, the present disclosure provides a communication system. The communication system includes an article of personal protective equipment (PPE). The article of PPE includes a plurality of first communication circuits corresponding to a plurality of communication channels. The article of PPE further includes a first memory configured to store a plurality of data types. The article of PPE further includes a first controller communicably coupled to the plurality of first communication circuits and the first memory. The communication system further includes a plurality of external devices remote from the article of PPE. Each of the plurality of external devices includes at least one second communication circuit communicably coupled to at least one of the plurality of first communication circuits via the corresponding communication channel. The first controller is configured to receive one or more data signals. The one or more data signals have corresponding data types from the plurality of data types. The first controller is further configured to determine a signal strength of each of the plurality of communication channels. The first controller is further configured to generate available connections data for the plurality of communication channels based on the signal strength of each of the plurality of communication channels. The first controller is further configured to determine the corresponding data types of the one or more data signals by comparing the one or more data signals with the plurality of data types stored in the first memory. The first controller is further configured to determine one or more available communication channels from the plurality of communication channels based on the available connections data. The one or more available communication channels are available to transmit the one or more data signals. The first controller is further configured to select at least one available communication channel from the one or more available communication channels based on at least the corresponding data types of the one or more data signals. The first controller is further configured to select at least one first communication circuit from the plurality of first communication circuits corresponding to the at least one available communication channel, such that the at least one first communication circuit receives the one or more data signals and transmits the one or more data signals to one or more external devices from the plurality of external devices over the at least one available communication channel.

In a third aspect, the present disclosure provides a computer-implemented method of communication. The method includes receiving one or more data signals. The one or more data signals have corresponding data types. The method further includes obtaining available connections data for a plurality of communication channels based on a signal strength of each of the plurality of communication channels. The method further includes determining one or more available communication channels from the plurality of communication channels based on the available connections data. The one or more available communication channels are available to transmit the one or more data signals. The method further includes creating a first list of the one or more available communication channels. If the first list of the one or more available communication channels includes one available communication channel, the method further includes transmitting the one or more data signals to one or more external devices from a plurality of external devices over the one available communication channel. If the first list of the one or more available communication channels includes more than one available communication channel, the method further includes determining the corresponding data types of the one or more data signals by comparing the one or more data signals with a plurality of data types stored in a memory. Further, if the first list of the one or more available communication channels includes the more than one available communication channel, the method includes determining one or more incompatible available communication channels from the first list of the one or more available communication channels based on the corresponding data types of the one or more data signals. The one or more incompatible available communication channels are not suitable for transmitting the corresponding data types of the one or more data signals. Furthermore, if the first list of the one or more available communication channels includes the more than one available communication channel, the method includes removing the one or more incompatible available communication channels from the first list of the one or more available communication channels to create a second list of one or more available communication channels. Furthermore, if the first list of the one or more available communication channels includes the more than one available communication channel, the method includes transmitting the one or more data signals to the one or more external devices over the one or more available communication channels from the second list.

In a fourth aspect, the present disclosure provides a computer program product including a computer readable medium having computer readable code embodied therein. The computer readable code is configured such that, on execution by a suitable computer or processing unit, the computer or processing unit is caused to perform the computer-implemented method of the third aspect of the present disclosure.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

Exemplary embodiments disclosed herein is more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labelled with the same number.

FIG. 1 illustrates a detailed schematic representation of a communication system including an article of personal protective equipment (PPE), according to an embodiment of the present disclosure;

FIG. 2 illustrates a schematic representation of the one or more data signals including a plurality of data packets, according to an embodiment of the present disclosure;

FIG. 3 illustrates an exemplary communication system;

FIG. 4 illustrates an exemplary communication system;

FIG. 5 illustrates an exemplary communication system;

FIG. 6 illustrates an exemplary communication system; and

FIG. 7 illustrates a flowchart depicting a computer implemented method of communication, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and is made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, “at least one of A and B” should be understood to mean “only A, only B, or both A and B”.

As used herein, the term “hazardous or potentially hazardous environmental conditions” may refer to environmental conditions that may be harmful to a human being, such as high noise levels, high ambient temperatures, lack of oxygen, presence of explosives, exposure to radioactive or biologically harmful materials, and exposure to other hazardous substances. Depending upon the type of safety equipment, environmental conditions and physiological conditions, corresponding thresholds or levels may be established to help define hazardous and potentially hazardous environmental conditions.

As used herein, the term “hazardous or potentially hazardous environments” may refer to environments that include hazardous or potentially hazardous environmental conditions. The hazardous or potentially hazardous environments may include, for example, chemical environments, biological environments, nuclear environments, fires, industrial sites, construction sites, agricultural sites, mining sites, or manufacturing sites.

As used herein, the term “an article of personal protective equipment (PPE)” may include any type of equipment or clothing that may be used to protect a user from hazardous or potentially hazardous environmental conditions. In some examples, one or more individuals, such as the users, may utilize the article of PPE while engaging in tasks or activities within the hazardous or potentially hazardous environment. Examples of the articles of PPE may include, but are not limited to, hearing protection (including ear plugs and ear muffs), respiratory protection equipment (including disposable respirators, reusable respirators, powered air purifying respirators, self-contained breathing apparatus and supplied air respirators), facemasks, oxygen tanks, air bottles, protective eyewear, such as visors, goggles, filters or shields (any of which may include augmented reality functionality), protective headwear, such as hard hats, hoods or helmets, protective shoes, protective gloves, other protective clothing, such as coveralls, aprons, coat, vest, suits, boots and/or gloves, protective articles, such as sensors, safety tools, detectors, global positioning devices, mining cap lamps, fall protection harnesses, exoskeletons, self-retracting lifelines, heating and cooling systems, gas detectors, and any other suitable gear configured to protect the users from injury. The articles of PPE may also include any other type of clothing or device/equipment that may be worn or used by the users to protect against extreme noise levels, extreme temperatures, fire, reduced oxygen levels, explosions, reduced atmospheric pressure, radioactive, and/or biologically harmful materials.

As used herein, the term “communicably coupled to” refers to direct coupling between components and/or indirect coupling between components via one or more intervening components. Such components and intervening components may comprise, but are not limited to, junctions, communication paths, components, circuit elements, circuits, functional blocks, and/or devices. As an example of indirect coupling, a signal conveyed from a first component to a second component may be modified by one or more intervening components by modifying the form, nature, or format of information in a signal, while one or more elements of the information in the signal are nevertheless conveyed in a manner than can be recognized by the second component.

As used herein, the term “network” may be associated with transmission of messages, packets, signals, and/or other forms of information between and/or within one or more network devices. In some examples, the network may include one or more wired and/or wireless networks operated in accordance with any communication standard that is or becomes known or practicable.

As used herein, the term “communication channel” may refer to a path, a conduit, a logical channel, or any means of communication that enables or supports a communication interaction or an exchange of information between two or more devices or parties. The communication channel may be wired or wireless.

As used herein, the term “signal,” includes, but is not limited to, one or more electrical signals, optical signals, electromagnetic signals, analog and/or digital signals, one or more computer instructions, a bit and/or bit stream, or the like.

Typically, articles of personal protective equipment (PPE) may be used by personnel working in hazardous or potentially hazardous environments, for example, burning buildings. In such hazardous or potentially hazardous environments, there is a need for communicating data, such as information, instructions, and telemetry data with devices of other personnel (e.g., emergency responders) or a central base station. The data may be of different types, such as critical data, text data, video data, audio data, configuration data, and the like. Different data may have different priority levels.

In some cases, the wireless communications may be compromised by metal structures, tower proximity, weak signal, etc. in the hazardous or potentially hazardous environments. Further, a conventional article of PPE may not provide reliable communication between the personnel and the other personnel or the central base station due to limited communication channels present for communication in the conventional article of PPE. The limited communication channels may also lead to a limited bandwidth available for exchange of the data. Furthermore, as the conventional article of PPE may not provide reliable communication, the data may not be successfully transmitted to intended recipient(s) (e.g., the other personnel and/or the central base station). In some cases, the data may be the critical data, or the priority level of the data may be high. Unsuccessful transmission of such data may be undesirable.

In an aspect, the present disclosure provides an article of personal protective equipment (PPE). The article of PPE includes a plurality of communication circuits corresponding to a plurality of communication channels. The article of PPE further includes a memory configured to store a plurality of data types. The article of PPE further includes a controller communicably coupled to the plurality of communication circuits and the memory. The controller is configured to receive one or more data signals. The one or more data signals have corresponding data types from the plurality of data types. The controller is further configured to determine a signal strength of each of the plurality of communication channels. The controller is further configured to generate available connections data for the plurality of communication channels based on the signal strength of each of the plurality of communication channels. The controller is further configured to determine the corresponding data types of the one or more data signals by comparing the one or more data signals with the plurality of data types stored in the memory. The controller is further configured to determine one or more available communication channels from the plurality of communication channels based on the available connections data. The one or more available communication channels are available to transmit the one or more data signals. The controller is further configured to select at least one available communication channel from the one or more available communication channels based on at least the corresponding data types of the one or more data signals. The controller is further configured to select at least one communication circuit from the plurality of communication circuits corresponding to the at least one available communication channel, such that the at least one communication circuit receives the one or more data signals and transmits the one or more data signals to one or more external devices over the at least one available communication channel. In another aspect, the present disclosure provides a communication system including the article of PPE. In another aspect, the present disclosure provides a computer-implemented method of communication.

Since, the article of PPE of the present disclosure provides the plurality of communication channels for exchange of the one or more data signals, a greater bandwidth may be available for exchange of the one or more data signals. As a result, the plurality of communication channels may improve a probability of a successful transmission of the one or more data signals. Further, in cases one or more communication channels are unavailable for transmission of the one or more data signals, the one or more data signals may still be transmitted to intended recipient(s) via the remaining communication channels. Moreover, the article of PPE may select communications channels based on the data type of the one or more data signals. This may further improve the probability of the successful transmission of the one or more data signals.

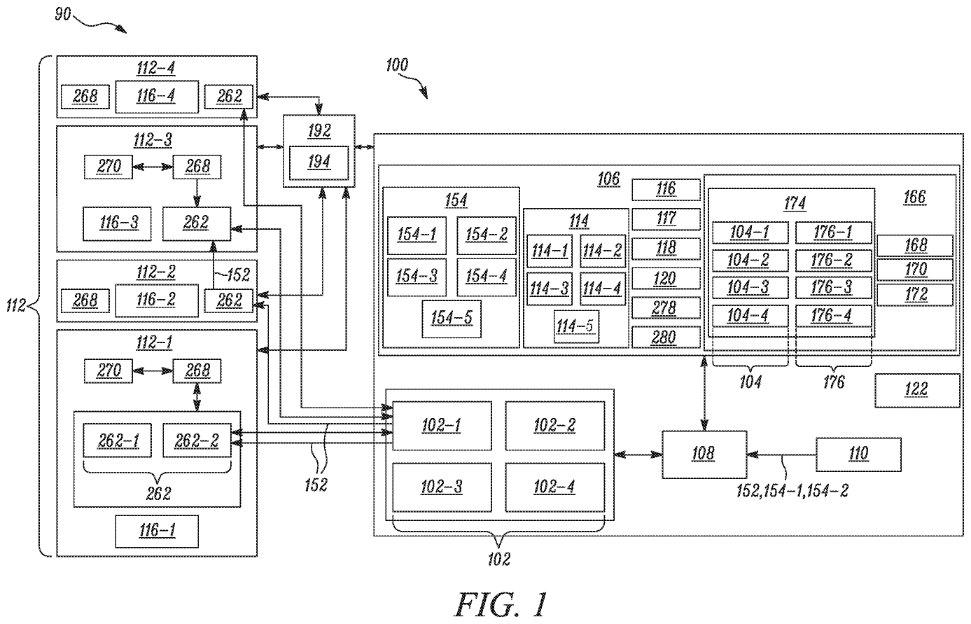

Referring to figures, FIG. 1 illustrates a detailed schematic representation of a communication system 90 including an article of personal protective equipment (PPE) 100, according to an embodiment of the present disclosure. The article of PPE 100 may be interchangeably referred to as “the article 100”. In some embodiments, the article 100 may be used by a user (not shown) in an environment, such as a hazardous or potentially hazardous environment. In some examples, the user of the article 100 may be any emergency personnel, such as firefighters, first responders, healthcare professionals, paramedics, HAZMAT workers, security personnel, law enforcement personnel, or any other personnel working in the environment. In the cases where the user is a firefighter, the article 100 may be worn by the firefighter in the environment. In some embodiments, the article 100 may include a breathing apparatus. In some embodiments, the article 100 includes a self-contained breathing apparatus (SCBA). In some other embodiments, the article 100 may include a respiratory protective equipment (RPS), a powered air purifying respirator (PAPR), a non-powered purifying respirator (APR), a self-retracting lifeline (SRL), or combinations thereof.

The article 100 includes a plurality of communication circuits 102 corresponding to a plurality of communication channels 104. In some embodiments, the plurality of communication circuits 102 may be configured to transmit data signals over corresponding communication channels 104.

In some embodiments, the plurality of communication circuits 102 corresponds to a plurality of communication technologies. In some embodiments, the plurality of communication technologies includes at least one of a long range (LoRa) network communication technology, a Bluetooth low energy (BLE) communication technology, a Wi-Fi communication technology, a WiMax communication technology, a cellular communication technology, a wide area network (WAN) communication technology, a Narrow Band-Internet of Things (NB-IoT) communication technology, a Digital enhanced cordless telecommunications (DECT) communication technology, a Radio frequency (RF) communication technology, a Wi-Fi direct communication technology, a Long-Term Evolution (LTE) communication technology, a Voice over Long Term Evolution (VoLTE) communication technology, a Land Mobile Radio (LMR) communication technology, an ultra-wideband (UWB) communication technology, and a custom communication technology. In some embodiments, the plurality of communication technologies may include a wired communication technology. In some embodiments, the plurality of communication technologies may include any other communication technology based on the desired application attributes.

In the illustrated embodiment of FIG. 1, the article 100 includes four communication circuits 102-1, 102-2, 102-4, 102-4 corresponding to communication channels 104-1, 104-2, 104-3, 104-4 of the plurality of communication channels 104. In some embodiments, at least two of the communication circuits 102-1 to 102-4 may correspond to different communication technologies. In some embodiments, the plurality of communication circuits 102 may include at least two primary communication circuits (e.g., the communication circuits 102-1, 102-2) and one or more secondary communication circuits (e.g., the communication circuits 102-3 and/or 102-4). The one or more secondary communication circuits may be utilized when the corresponding primary communication circuits fail. In some other embodiments, each of the communication circuits 102-1 to 102-4 may correspond to different communication technologies.

The article 100 further includes a memory 106 configured to store a plurality of data types 154. In some embodiments, the plurality of data types 154 includes at least one of a video-data type 154-1 indicative of video data, an audio-data type 154-2 indicative of audio data, a text-data type 154-3 indicative of text data, a configuration-data type 154-4 indicative of configuration data, and a critical-data type 154-5 indicative of critical data 166. In some embodiments, the critical data 166 includes at least one of personal alarm safety system (PASS) data 168, location data 170, telemetry data 172, and available connections data 174.

The article 100 further includes a controller 108 communicably coupled to the plurality of communication circuits 102 and the memory 106. In some embodiments, the controller 108 may include any suitable type of processing circuitry, such as one or more general-purpose controller or microcontroller or processors (e.g., ARM-based processors), a Digital Signal Processor (DSP), a Programmable Logic Device (PLD), an Application-Specific Integrated Circuit (ASIC), a Field-Programmable Gate Array (FPGA), etc.

In some embodiments, the plurality of communication circuits 102 may be interchangeably referred to as “the plurality of first communication circuits 102”, the memory 106 may be interchangeably referred to as “the first memory 106”, and the controller 108 may be interchangeably referred to as “the first controller 108”. Therefore, in such embodiments, the article 100 includes the plurality of first communication circuits 102 corresponding to the plurality of communication channels 104, the first memory 106 configured to store the plurality of data types 154, and the first controller 108 communicably coupled to the plurality of first communication circuits 102 and the first memory 106.

The communication system 90 further includes a plurality of external devices 112 remote from the article 100. Each of the plurality of external devices 112 includes at least one second communication circuit 262 communicably coupled to at least one of the plurality of first communication circuits 102 via the corresponding communication channel. In the illustrated embodiment of FIG. 1, the communication system 90 includes four external devices 112-1, 112-2, 112-3, 112-4. The external device 112-1 is shown in greater detail for clarity. The at least one second communication circuit 262 of the external device 112-1 includes two second communication circuits 262-1, 262-2. Further, the second communication circuit 262-2 is communicably coupled to the first communication circuit 102-1 via the communication channel 104-1. In some embodiments, each of the plurality of external devices 112 includes a second controller 268. In some embodiments, the second controller 268 may be communicably coupled to the first controller 108. In some embodiments, the second controller 268 may include any suitable type of processing circuitry, such as one or more general-purpose controller or microcontroller or processors (e.g., ARM-based processors), a Digital Signal Processor (DSP), a Programmable Logic Device (PLD), an Application-Specific Integrated Circuit (ASIC), a Field-Programmable Gate Array (FPGA), etc.

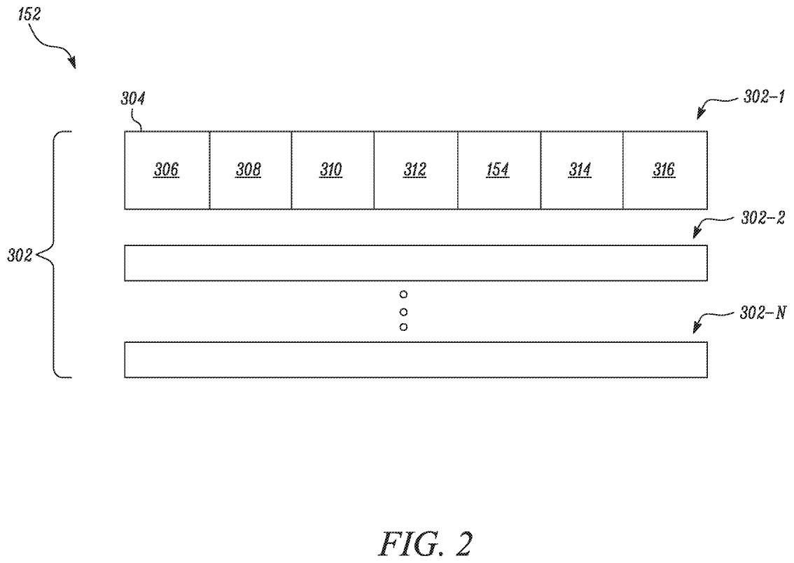

The controller 108 is configured to receive the one or more data signals 152 having corresponding data types from the plurality of data types 154. In some embodiments, each of the one or more data signals 152 includes a plurality of data packets 302 (shown in FIG. 2).

In some embodiments, the controller 108 may be configured to receive the one or more data signals 152 from an input unit 110 communicably coupled to the controller 108. In some embodiments, the input unit 110 may include one or more of devices that may generate the one or more data signals 152.

In some embodiments, the article 100 may include the input unit 110. In some embodiments, the input unit 110 may include one or more sensors (not shown) configured to generate the telemetry data 172. For example, the one or more sensors may include one or more of a temperature sensor, a pressure sensor, a proximity sensor, an acoustic sensor, a chemical sensor, an electric sensor, an environmental condition sensor, a radiation sensor, an optical sensor, a humidity sensor, a light intensity sensor, a gyroscope, and an accelerometer. In some embodiments, the input unit 110 may include a position sensor, such as a Global Positioning System (GPS) configured to generate the location data 170.

In some embodiments, the input unit 110 may include a microphone (not shown) configured to generate the audio data.

In some embodiments, the input unit 110 may include a camera (not shown) configured to generate image and/or the video data.

In some embodiments, the input unit 110 may further include a user interface (not shown) configured to generate the configuration data and/or the text data.

The controller 108 is further configured to determine a signal strength 176 of each of the plurality of communication channels 104. In the illustrated embodiment of FIG. 1, the communication channels 104-1 to 104-4 have corresponding signal strengths 176-1, 176-2, 176-3, 176-4. Generally, a signal strength of a communication channel is an indicator of an ability of the communication channel to transmit data signals over the communication channel. In some embodiments, the signal strength 176 may be determined based on a channel signal to noise ratio (SNR). In some embodiments, a higher value of signal strength may correspond to a greater robustness of the communication channel, thereby indicating a greater ability of the communication channel to transmit the one or more data signals 152.

The controller 108 is further configured to generate the available connections data 174 for the plurality of communication channels 104 based on the signal strength 176 of each of the plurality of communication channels 104. In some embodiments, the available connections data 174 may be indicative of available communication channels for transmitting the one or more data signals 152. In some embodiments, the controller 108 is further configured to periodically generate the available connections data 174 at a predetermined time interval. In some embodiments, the controller 108 may further be configured to transmit the available connections data 174 to the plurality of external devices 112. Therefore, the controller 108 may periodically monitor the available communication channels between the article 100 and the plurality of external devices 112 to determine if the available communication channels are able to exchange the one or more data signals 152. In case there is a change in status of the available communication channels, i.e., in case a previously available communication channel is not able to exchange the one or more data signals 152, or if a new communication channel is able to exchange the one or more data signals 152, the controller 108 may be configured to update the available connections data 174.

The controller 108 is further configured to determine the corresponding data types of the one or more data signals 152 by comparing the one or more data signals 152 with the plurality of data types 154 stored in the memory 106. In some embodiments, the one or more data signals 152 may have the same data type 154. In some embodiments, the one or more data signals 152 may have different data types 154. For example, the one or more data signals 152 may include three data signals having the audio-data type 154-2, the text-data type 154-3, and the critical-data type 154-5, respectively.

The controller 108 is further configured to determine one or more available communication channels from the plurality of communication channels 104 based on the available connections data 174. The one or more available communication channels are available to transmit the one or more data signals 152. For example, the controller 108 may determine that the communication channels 104-1, 104-2, 104-3, 104-4 from the plurality of communication channels 104 are available to transmit the one or more data signals 152 based on the available connections data 174.

The controller 108 is further configured to select at least one available communication channel from the one or more available communication channels based on at least the corresponding data types of the one or more data signals 152. As a result, the controller 108 may select the at least one available communication channel that has a required bandwidth for transmitting the one or more data signals 152.

For example, the controller 108 may select the communication channel 104-1 from the one or more available communication channels 104-1 to 104-4, if the communication channel 104-1 is suitable to transmit the corresponding data types of the one or more data signals 152.

In some cases, the one or more data signals 152 may include the critical-data type 154-5 and the audio-data type 154-2, and the communication channel 104-1 may be suitable to transmit the critical-data type 154-5 and the communication channel 104-2 may be suitable to transmit the audio-data type 154-2. In such cases, the controller 108 may select the communication channels 104-1, 104-2 from the one or more available communication channels 104-1 to 104-4.

In some embodiments, the at least one communication channel from the plurality of communication channels 104 is configured to transmit two or more data types from the plurality of data types 154. For example, in the illustrated embodiment of FIG. 1, the communication channel 104-1 from the one or more available communication channels 104-1 to 104-4 may be configured to transmit both the critical-data type 154-5 and the audio-data type 154-2. Therefore, the controller 108 may select the communication channel 104-1 from the one or more available communication channels 104-1 to 104-4.

The controller 108 is further configured to select at least one communication circuit from the plurality of communication circuits 102 corresponding to the at least one available communication channel, such that the at least one communication circuit receives the one or more data signals 152 and transmits the one or more data signals 152 to one or more external devices from the plurality of external devices 112 over the at least one communication channel.

For example, in the illustrated embodiment of FIG. 1, the controller 108 selects the communication channel 104-1 from the one or more available communication channels 104-1 to 104-4, the controller 108 further selects the communication circuit 102-1 from the plurality of communication circuits 102 corresponding to the communication channel 104-1, such that the communication circuit 102-1 receives the one or more data signals 152 and transmits the one or more data signals 152 to the one or more external devices 112-1, 112-2 over the communication channel 104-1.

In some other cases, if the controller 108 selects the communication channels 104-1, 104-2 from the one or more available communication channels 104-1 to 104-4, the controller 108 further selects the communication circuits 102-1, 102-2 from the plurality of communication circuits 102 corresponding to the communication channels 104-1, 104-2, such that the communication circuits 102-1, 102-2 receive the one or more data signals 152 and transmit the one or more data signals 152 to the one or more external devices 112-1, 112-2 over the communication channels 104-1, 104-2.

In some embodiments, the at least one available communication channel includes two or more available communication channels (e.g., the communication channels 104-1, 104-2). In some embodiments, the controller 108 is configured to sequentially select two or more communication circuits (e.g., the communication circuits 102-1, 102-2) corresponding to the two or more available communication channels, such that the two or more communication circuits receive the one or more data signals 152 and transmit the one or more data signals 152 one at a time to the one or more external devices over the two or more available communication channels. This may optimize energy consumption of the communication system 90 and may further reduce RF exposure to the user of the article 100.

In some embodiments, the at least one communication circuit further receives the available connections data 174 and transmits the available connections data 174 to the one or more external devices from the plurality of external devices 112 over the at least one communication channel.

In some embodiments, the plurality of external devices 112 includes one or more final external devices and one or more intermediate external devices. In some embodiments, the one or more external devices include the one or more final external devices or the one or more intermediate devices. In some embodiments, the one or more data signals 152 are intended to be received by the one or more final external devices. In some embodiments, the one or more intermediate external devices receive and transmit the one or more data signals 152 to the one or more final external devices. In some embodiments, the one or more final external devices includes at least one of one or more articles of PPE and one or more remote servers. In some embodiments, the one or more intermediate external devices includes at least one of an LTE tower, a cloud server, and a land mobile radio.

For example, in the illustrated embodiment of FIG. 1, the one or more data signals 152 are intended to be received by the external devices 112-1 and 112-3. Therefore, the external devices 112-1 and 112-3 may be the final external devices. Further, as shown, the one or more external devices includes the external devices 112-1 and 112-2. The one or more data signals 152 may not be intended to be received by the external device 112-2. Therefore, the external device 112-2 may be the intermediate external device. Further, the one or more external devices 112-1 to 112-2 includes the final external device 112-1 and the intermediate external device 112-2. The intermediate external device 112-2 may receive and transmit the one or more data signals 152 to the final external device 112-3 or another intermediate external device that may transmit the one or more data signals 152 to the final external device 112-3.

Thus, the one or more intermediate external devices may transmit the one or more data signals 152 received from the article 100 to the one or more final external devices. Further, the one or more data signals 152 may be transmitted from the article 100 to the one or more final external devices (e.g., the external device 112-3) even in the event that there is no direct communication channel therebetween, via the one or more intermediate external devices (e.g., the external device 112-2).

In some embodiments, the one or more final external devices (e.g., the external devices 112-1, 112-3) from the one or more external devices further includes a display 270 communicably coupled to the second controller 268. In some embodiments, the display 270 may be a heads-up display (HUD). In some embodiments, upon receipt of the one or more data signals 152 from the article 100, the second controller 268 of each of the one or more final external devices is configured to display at least one data corresponding to at least one of the one or more data signals 152 on the display 270. In some embodiments, the second controller 268 is configured to display the text data when the at least one of the one or more data signals 152 includes the text-data type 154-3 on the display 270. In other embodiments, the second controller 268 of each of the one or more final external devices may be configured to display the video data when the at least one of the one or more data signals 152 includes the video-data type 154-1 on the display 270. In some embodiments, the second controller 268 of each of the one or more final external devices may be configured to display the critical data 166 when the at least one of the one or more data signals 152 includes the critical-data type 154-5 on the display 270.

In some embodiments, the second controller 268 of each of the one or more final external devices may be configured to output the audio data via one or more hearing devices and/or speakers when the at least one of the one or more data signals 152 includes the audio-data type 154-2. The one or more hearing devices may include a wired/wireless headphone and/or an earphone. In some embodiments, the second controller 268 of each of the one or more final external devices may be configured to output the critical data 166 when the at least one of the one or more data signals 152 includes the critical-data type 154-5 via the one or more hearing devices and/or the speakers.

In some embodiments, the second controller 268 of each of the one or more final external devices may be configured to configure one or more settings of the one or more final external devices based on the configuration data when the at least one of the one or more data signals 152 includes the configuration-data type 154-4. For example, the one or more final external devices may be a facepiece/mask and the configuration data may include facepiece/mask configuration data.

In some embodiments, the second controller 268 of each of the plurality of external devices 112 may be configured to generate external connections data 280 for the corresponding communication channels based on signal strength of each of the corresponding communication channels. The second controller 268 may transmit the external connections data 280 to the controller 108 of the article 100. Specifically, the second controller 268 of each of the one or more final external devices and the one or more intermediate external devices may generate and transmit the external connections data 280 to the controller 108 of the article 100. In some embodiments, the second controller 268 is configured to periodically transmit the external connections data 280 to the controller 108 of the article 100 at a predetermined time interval. The controller 108 is further configured to receive the external connections data 280 from each of the plurality of external devices 112. The external connections data 280 is indicative of communication channels available with the respective external devices. The memory 106 is further configured to store the external connections data 280. In some embodiments, the controller 108 is further configured to select the at least one available communication channel from the one or more available communication channels further based on the external connections data 280. In some embodiments, the controller 108 may cross-reference the available connections data 174 with the external connections data 280 to select the at least one available communication channel from the one or more available communication channels. This may reduce a likelihood of the controller 108 to select the at least one available communication channel from the one or more available communication channels which may be unavailable to any of the one or more final external devices and the one or more intermediate external devices.

In some embodiments, the memory 106 is further configured to store a plurality of priority levels 114 corresponding to the plurality of data types 154. In some embodiments, the plurality of priority levels 114 includes first, second, third, fourth, and fifth priority levels 114-1, 114-2, 114-3, 114-4, 114-5.

In some embodiments, the first priority level 114-1 is greater than the second priority level 114-2. In some embodiments, the second priority level 114-2 is greater than the third priority level 114-3. In some embodiments, the third priority level 114-3 is greater than the fourth priority level 114-4. In some embodiments, the fifth priority level 114-5 is greater than the fourth priority level 114-4.

In some embodiments, the first, second, third, fourth, and fifth priority levels 114-1, 114-2, 114-3, 114-4, 114-5 correspond to the critical-data type 154-5, the text-data type 154-3, the configuration-data type 154-4, the audio-data type 154-2, and video-data type 154-1.

In some embodiments, the first priority level 114-1 of the critical-data type 154-5 is greater than the second priority level 114-2 of the text-data type 154-3. In some embodiments, the second priority level 114-2 of the text-data type 154-3 is greater than the third priority level 114-3 of the configuration-data type 154-4. In some embodiments, the third priority level 114-3 of the configuration-data type 154-4 is greater than the fourth priority level 114-4 of the audio-data type 154-2. In some embodiments, the fourth priority level 114-4 of the audio-data type 154-2 is greater than the fifth priority level 114-5 of the video-data type 154-1.

However, in some embodiments, the controller 108 is configured to assign the first, second, third, fourth, and fifth priority levels 114-1 to 114-5 to any of the critical-data type 154-5, the text-data type 154-3, the configuration-data type 154-4, the audio-data type 154-2, and video-data type 154-1 based on a user input. The user input may be defined by the user of the article 100 via the user interface (not shown).

In some embodiments, the controller 108 is further configured to determine the priority levels of the corresponding data types of the one or more data signals 152 by comparing the corresponding data types with the plurality of priority levels 114 stored in the memory 106. In some embodiments, the controller 108 is further configured to select the at least one available communication channel from the one or more available communication channels based further on the priority levels of the corresponding data types of the one or more data signals 152.

In some embodiments, the one or more data signals 152 include first and second data signals having corresponding first and second data types. In some embodiments, the priority level of the first data type is greater than the priority level of the second data type. In some embodiments, the at least one available communication channel includes one available communication channel configured to transmit both the first and second data types. In some embodiments, the controller 108 is further configured to select a communication circuit from the plurality of communication circuits 102 corresponding to the one available communication channel, such that the communication circuit receives the first and second data signals and transmits the first data signal to the one or more external devices over the one available communication channel prior to transmitting the second data signal to the one or more external devices over the one available communication channel.

For example, in some cases, the one or more data signals 152 may include the first and second data signals having the critical-data type 154-5 and the audio-data type 154-2, respectively. The priority level of the critical-data type 154-5 may be higher than the priority level of the audio-data type 154-2. Further, the at least one available communication channel may include only the communication channel 104-1 which may be configured to transmit both the critical-data type 154-5 and the audio-data type 154-2. In some embodiments, the controller 108 is further configured to select the communication circuit 102-1 from the plurality of communication circuits 102 corresponding to the communication channel 104-1, such that the communication circuit 102-1 receives the first and second data signals and transmits the first data signal to the one or more external devices 112-1, 112-2 over the communication channel 104-1 prior to transmitting the second data signal to the one or more external devices 112-1, 112-2 over the communication channel 104-1. Therefore, the controller 108 may ensure that the first data signal having the data type of a higher priority level is timely transmitted to the one or more external devices 112-1, 112-2.

In some embodiments, the memory 106 is further configured to store a predetermined hierarchy 118 of the plurality of communication technologies. In some embodiments, the controller 108 is configured to select the at least one available communication channel from the one or more available communication channels based further on the predetermined hierarchy 118 of the plurality of communication technologies.

For example, in some cases, the Wi-Fi communication technology may have a higher hierarchy than the cellular communication technology. Therefore, the controller 108 may select the at least one available communication channel from the one or more available communication channels corresponding to the Wi-Fi communication technology even when the one or more available communication channels include a communication channel corresponding to the cellular communication technology.

In some embodiments, the predetermined hierarchy 118 of the plurality of communication technologies may be based on bandwidths of communication technologies. In some cases, the communication technologies having a greater bandwidth may have the higher hierarchy. In some embodiments, the predetermined hierarchy 118 of the plurality of communication technologies may be user defined. This may further optimize the transmission of the one or more data signals 152.

In some embodiments, the memory 106 is further configured to store a plurality of user channel preferences 120. In some embodiments, the controller 108 is further configured to select the at least one available communication channel from the one or more available communication channels based further on the plurality of user channel preferences 120. For example, the one or more available communication channels may include the communication channels 104-1 to 104-3 from the plurality of communication channels 104. The communication channel 104-1 may have a higher user channel preference than the communication channels 104-2, 104-3. In such cases, the controller 108 may select the communication channel 104-1, such that the communication circuit (e.g., the communication circuit 102-1) the corresponding to the communication channel 104-1 receives the one or more data signals 152 and transmits the one or more data signals 152 to the one or more external devices over the communication channel 104-1.

In some embodiments, the plurality of external devices 112 includes corresponding plurality of device identifiers 116. In the illustrated embodiment of FIG. 1, the external devices 112-1 to 112-4 include the corresponding device identifiers 116-1, 116-2, 116-3, 116-4. Similarly, the article 100 may also include a device identifier 117. In some embodiments, the device identifier 117 of the article 100 may be stored in the memory 106.

In some embodiments, the memory 106 is further configured to store the plurality of device identifiers 116 corresponding to the plurality of external devices 112. In some embodiments, the controller 108 is further configured to select some of the external devices from the plurality of external devices 112 based on the plurality of device identifiers 116 of the plurality of external devices 112. In some embodiments, the controller 108 may select the some of the external devices from the plurality of external devices 112 based on the data type and/or the priority level of the one or more data signals 152, and/or status of the plurality of external devices 112. Further, in some embodiments, the some of the external devices 112 include the one or more external devices. In some embodiments, the selected some of the external devices from the plurality of external devices 112 includes the at least one second communication circuit 262 corresponding to the Wi-Fi direct communication technology.

In some embodiments, the some of the external devices may be selected by the controller 108 based on a user input. The user input may be provided by the user of the article 100 via the user interface (not shown). The user of the article 100 may select the some of the external devices based on the communication requirements, for example, the user of the article 100 may select the some of the external devices to form a group. In other words, the user may be able to select the some of the external devices and remove some of the external devices from the plurality of the external devices 112 of the communication system 90, based on the communication requirements.

In some embodiments, the controller 108 is further configured to generate and store a network data 278 indicative of the selected some of the external devices from the plurality of external devices 112 in the memory 106. For example, the controller 108 may select the external devices 112-1, 112-2. Therefore, the controller 108 may further generate the network data 278 indicative of the selected external devices 112-1, 112-2 and may store the network data 278 in the memory 106.

In some embodiments, the communication system 190 further includes a common cloud server 192 communicably coupled to the article 100. In some embodiments, the communication system 190 further includes the common cloud server 192 communicably coupled to each of the article 100 and the plurality of external devices 112. In some embodiments, the common cloud server 192 includes a cloud memory 194. In some embodiments, the first controller 108 is further configured to transmit the network data 278 to the common cloud server 192. In some embodiments, the cloud memory 194 is configured to store the network data 278.

In some embodiments, the first controller 108 is further configured to determine a relative distance between the article 100 and some of the plurality of external devices 112 including the at least one second communication circuit 262 corresponding to the UWB communication technology. This may be beneficial in low visibility conditions, for example, in the hazardous or potentially hazardous environment including smoke, fire, and/or debris.

In some embodiments, the first controller 108 may determine the relative distance between the article 100 and the some of the plurality of external devices 112 based on the signal strength 176 of respective communication channels corresponding to the UWB communication technology. In some embodiments, a greater signal strength 176 of the respective communication channels may indicate a lesser distance between the article 100 and the some of the plurality of external devices 112.

In some embodiments, the article 100 further includes at least one barrier circuit 122 including at least one of one or more diodes (not shown), one or more fuses (not shown), and one or more resistors (not shown). In some embodiments, the at least one barrier circuit 122 is configured to limit a maximum electrical power in the article 100, such that the article 100 complies with an Intrinsic Safety (IS) specification. In the illustrated embodiment of FIG. 1, the article 100 includes one barrier circuit 122. Therefore, the article 100 may be intrinsically safe.

FIG. 2 illustrates a schematic representation of the one or more data signals 152, according to an embodiment of the present disclosure. In some embodiments, each of the one or more data signals 152 includes a plurality of data packets 302. In the illustrated embodiment of FIG. 2, each of the one or more data signals 152 include the data packets 302-1, 302-2 . . . 302-N. The data packets 302-1 to 302-N may be individually and collectively referred to by the reference numeral 302. FIG. 2 further illustrates a detailed schematic representation of the data packet 302-1.

In some embodiments, each data packet 302 includes a packet structure 304. The packet structure 304 includes one or more recipient device identifiers 306, a source device identifier 308, one or more intermediate device identifiers 310, a packet serial number 312, the data type 154, a payload 314, and a cyclic redundancy check (CRC) 316.

In some embodiments, the payload 314 may refer to a portion of the data packet 302 that contains a data of interest that is being transmitted by the article 100 to the one or more external devices 112. In some embodiments, the CRC 316 in the data packet 302 may be used for detection of errors in the payload 314 after the data packet 302 is received by the one or more external devices 112. Specifically, the CRC 316 may be used to determine if one or more errors have been introduced into the payload 314 during transmission of the data packet 302.

Referring now to FIGS. 1 and 2, in some embodiments, the one or more recipient device identifiers 306 are indicative of device identifiers (e.g., the device identifiers 116-1, 116-3) of the one or more final external devices (e.g., the final external devices 112-1, 112-3), the source device identifier 308 is indicative of the device identifier 117 of the article 100, and the one or more intermediate device identifiers 310 are indicative of device identifiers (e.g., the device identifier 116-2) of the one or more intermediate devices (e.g., the intermediate external device 112-2).

In some embodiments, upon receipt of the data packet (e.g., the data packet 302-1) of the one or more data signals 152 by the one or more external devices (e.g., the external devices 112-1, 112-2), the second controller 268 of each the one or more external devices 112-1, 112-2 is configured to obtain the packet serial number 312 from the packet structure 304 of the data packet 302-1. In some embodiments, the second controller 268 of each the one or more external devices 112-1, 112-2 is further configured to compare the packet serial number 312 with a previous packet serial number of a previous data packet (not shown) received prior to the data packet 302-1. In some embodiments, the second controller 268 of each the one or more external devices 112-1, 112-2 is further configured to discard the data packet 302-1 if the packet serial number 312 matches with the previous packet serial number. Therefore, this may ensure that there is no duplication of data packets, and a data packet is processed only once by the one or more external devices 112-1, 112-2.

In some embodiments, upon receipt of the data packet 302 of the one or more data signals 152 by the one or more external devices, the second controller 268 of each the one or more external devices is configured to obtain the one or more recipient device identifiers 306 from the packet structure 304 of the data packet 302. In some embodiments, the second controller 268 of each the one or more external devices is further configured to compare the one or more recipient device identifiers 306 with the device identifier 116 of the external device. In some embodiments, the second controller 268 of each the one or more external devices is further configured to transmit the data packet 302 to the one or more final external devices having the one or more recipient device identifiers 306 or the one or more intermediate devices having the one or more intermediate device identifiers 310 from the packet structure 304 of the data packet 302 if the one or more recipient device identifiers 306 do not match with the device identifier 116 of the external device 112. For example, upon receipt of the data packet 302 of the one or more data signals 152 by the external devices 112-1, 112-2, the second controller 268 of the external devices 112-1, 112-2 are configured to obtain the one or more recipient device identifiers 306 from the packet structure 304 of the data packet 302. In some embodiments, the second controller 268 of the external devices 112-1, 112-2 are further configured to compare the one or more recipient device identifiers 306 with the respective device identifiers 116-1, 116-2 of the external devices 112-1, 11-2. The one or more recipient device identifiers 306 may match with the device identifier 116-1 of the external device 112-1. Further, the one or more recipient device identifiers 306 may not match with the device identifier 116-2 of the external device 112-2. The second controller 268 of the external device 112-2 is further configured to transmit the data packet 302 to the final external devices 112-3 having the one or more recipient device identifiers 306 or the one or more intermediate devices having the one or more intermediate device identifiers 310 from the packet structure 304 of the data packet 302.

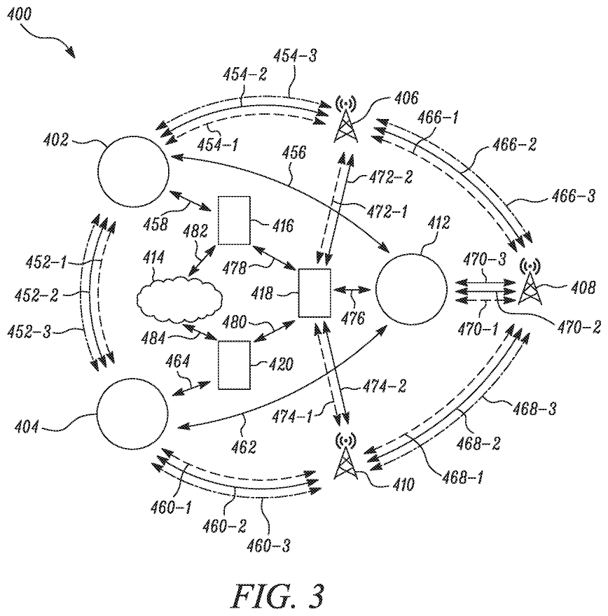

FIG. 3 illustrates an exemplary communication system 400. The communication system 400 includes an article of PPE 402 and a plurality of external devices. The plurality of external devices includes an article of PPE 404, LTE towers 406, 408, 410, a command center 412, a cloud server 414, and internet service provider (ISP) routers 416, 418, 420.

In the illustrated embodiment of FIG. 3, the article of PPE 402 is communicably coupled to the article of PPE 404, the LTE tower 406, the command center 412, and the ISP router 416. Specifically, the article of PPE 402 is communicably coupled to the article of PPE 404 via communication channels 452-1, 452-2, 542-3, to the LTE tower 406 via communication channels 454-1, 454-2, 454-3, to the command center 412 via a communication channel 456, and to the ISP router 416 via a communication channel 458. The communication channels 452-1, 454-2, 452-3 correspond to the DECT, Wi-Fi Direct, and LoRa communication technologies, respectively. The communication channels 454-1, 454-2, 454-3 correspond to the VoLTE, LTE, and NB-IoT communication technologies, respectively. The communication channel 456 corresponds to the LoRa communication technology. The communication channel 458 corresponds to the Wi-Fi communication technology.

Further, the article of PPE 404 is communicably coupled to the LTE tower 410, the command center 412, and the ISP router 420. Specifically, the article of PPE 404 is communicably coupled to the LTE tower 410 via communication channels 460-1, 460-2, 460-3, to the command center via a communication channel 462, and to the ISP router 420 via a communication channel 464. The communication channels 460-1, 460-2, 460-3 correspond to the VoLTE, LTE, and NB-IoT communication technologies, respectively. The communication channel 462 corresponds to the LoRa communication technology. The communication channel 464 corresponds to the Wi-Fi communication technology.

Further, the LTE tower 408 is communicably coupled to the LTE towers 406, 410, and the command center 412. Specifically, the LTE tower 408 is communicably coupled to the LTE tower 406 via communication channels 466-1, 466-2, 466-3, to the LTE tower 410 via communication channels 468-1, 468-2, 468-3, and to the command center 412 via communication channels 470-1, 470-2, 470-3. The communication channels 466-1, 466-2, 466-3 correspond to the VoLTE, LTE, and NB-IoT communication technologies, respectively. The communication channels 468-1, 468-2, 468-3 correspond to the VoLTE, LTE, and NB-IoT communication technologies, respectively. The communication channels 470-1, 470-2, 470-3 correspond to the VoLTE, LTE, and NB-IoT communication technologies, respectively.

Further, the ISP router 418 is communicably coupled to the LTE towers 406, 410, the command center 412, and the ISP routers 416, 420. Specifically, the ISP router 418 is communicably coupled to the LTE tower 406 via communication channels 472-1, 472-2, to the LTE tower 410 via communication channels 474-1, 474-2, to the command center 412 via a communication channel 476, to the ISP router 416 via a communication channel 478, and to the ISP router 420 via a communication channel 480. The communication channels 472-1, 472-2 correspond to the NB-IoT and LTE communication technologies, respectively. The communication channels 474-1, 474-2 correspond to the NB-IoT and LTE communication technologies, respectively. The communication channel 476 corresponds to the Wi-Fi communication technology. Each of the communication channels 478, 480 corresponds to a hardwired communication technology. In other words, the communication channels 478, 480 corresponds to the wired communication technology.

Further, the cloud server 414 is communicably coupled to the ISP routers 416, 420.

Specifically, the cloud server 414 is communicably coupled to the ISP router 416 via a communication channel 482 and to the ISP router 420 via a communication channel 484. Each of the communication channels 482, 484 includes a hardwired communication technology.

The one or more data signals 152 (shown in FIG. 1) may be exchanged between the article of PPE 402 and one or more of the external devices, or between one or more of the external devices.

The communication channels 452 to 484 may have different capabilities for exchange of the one or more data signals 152. In other words, each of the communication channels 452 to 484 may be capable of exchanging one or more the plurality of data types 154.

For example, the LTE, Wi-Fi, Wi-Fi Direct, and hardwired communication technologies may allow exchange of all the data types 154. Further, the DECT and VoLTE communication technologies may allow exchange of the audio-data types 154-2. Furthermore, the LoRa and NB-IoT communication technologies may allow for exchange of the critical-data type 154-5, the configuration-data type 154-4, and the text-data type 154-3.

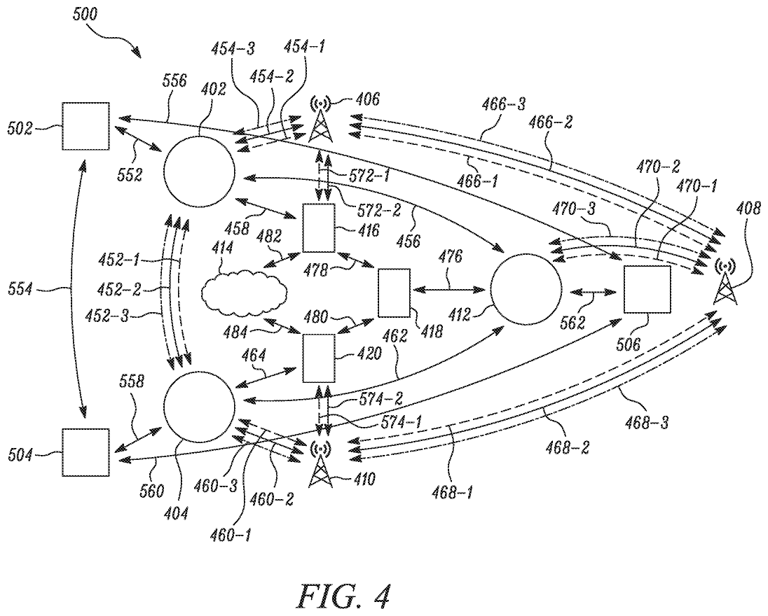

FIG. 4 illustrates an exemplary communication system 500. The communication system 500 is substantially similar to the communication system 400 of FIG. 3. Common components between the communication system 400 and the communication system 500 are referred to by the same reference numerals. The communication system 500 further includes land mobile radios (LMR) 502, 504, 506 communicably coupled to each other.

Further, the LMR 502 is communicably coupled to the article of PPE 402, the LMR 504 is communicably coupled to the article of PPE 404, and the LMR 506 is communicably coupled to the command center 412. Specifically, the LMR 502 is communicably coupled to the article of PPE 402 via a communication channel 552, to the LMR 504 via a communication channel 554, and to the LMR 506 via a communication channel 556. The LMR 504 is communicably coupled to the article of PPE 404 via a communication channel 558 and to the LMR 506 via a communication channel 560. The LMR 506 is communicably coupled to the command center 412 via a communication channel 562. Each of the communication channels 552, 558, 562 corresponds to the BLE communication technology. Each of the communication channels 554, 556, 560 corresponds to the LMR communication technology.

In the illustrated example of FIG. 4, the LMRs 502, 504, 506 are communicably coupled to the article of PPE 402, the article of PPE 404, and the command center 412, respectively, via the BLE communication technology. The BLE communication technology may allow exchange of the audio-data types 154-2. Further, the LMR communication technology may also allow exchange of the audio-data types 154-2.

Further, the ISP router 416 is communicably coupled to the LTE tower 406 via communication channels 572-1, 572-2. The communication channels 572-1, 572-2 correspond to the NB-IoT and LTE communication technologies, respectively. Furthermore, the ISP router 420 is communicably coupled to the LTE tower 410 via communication channels 574-1, 574-2. The communication channels 574-1, 574-2 correspond to the NB-IoT and LTE communication technologies, respectively.

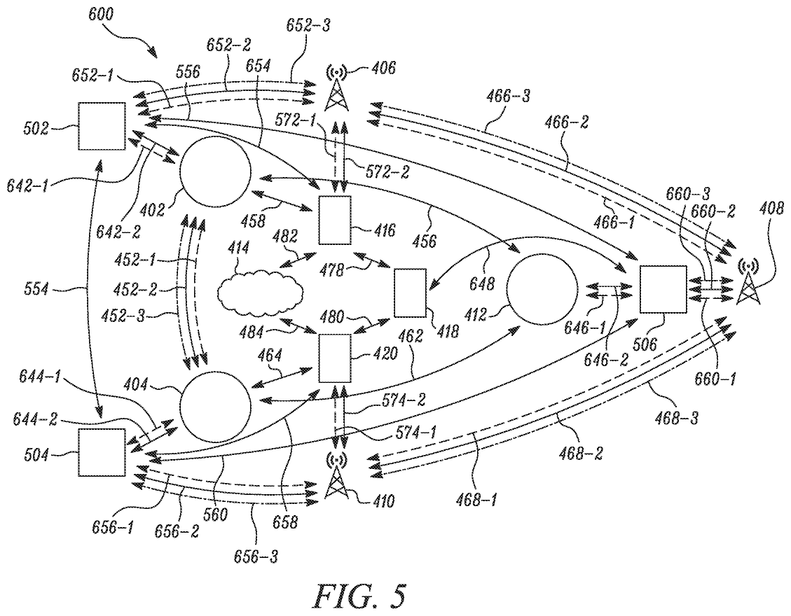

FIG. 5 illustrates an exemplary communication system 600. The communication system 600 is substantially similar to the communication system 500 of FIG. 4. Common components between the communication system 500 and the communication system 600 are referred to by the same reference numerals.

The LMR 502 is further communicably coupled to the article of PPE 402, the LTE tower 406, and the ISP router 416. Specifically, the LMR 502 is communicably coupled to the article of PPE 402 via communication channels 642-1, 642-2, to the LTE tower 406 via communication channels 652-1, 652-2, 652-3, and to the ISP router 416 via a communication channel 654. The communication channels 642-1, 642-2 correspond to the BLE, and Wi-Fi communication technologies, respectively. The communication channels 652-1, 652-2, 652-3 correspond to the NB-IoT, VoLTE, and LTE communication technologies, respectively. The communication channel 654 corresponds to the Wi-Fi communication technology.

The LMR 504 is further communicably coupled to the article of PPE 404, the LTE tower 410, and the ISP router 420. Specifically, the LMR 504 is communicably coupled to the article of PPE 404 via communication channels 644-1, 644-2, to the LTE tower 410 via communication channels 656-1, 656-2, 656-3 and to the ISP router 420 via a communication channel 658. The communication channels 644-1, 644-2 correspond to the BLE and Wi-Fi communication technologies, respectively. The communication channels 656-1, 656-2, 656-3 correspond to the NB-IoT, VoLTE, and LTE communication technologies, respectively. The communication channel 658 corresponds to the Wi-Fi communication technology.

The LMR 506 is communicably coupled to the LTE tower 408, to the command center 412, and to the ISP router 418. Specifically, the LMR 506 is communicably coupled to the LTE tower 408 via communication channels 660-1, 660-2, 660-3, to the command center 412 via communication channels 646-1, 646-2, and to the ISP router 418 via a communication channel 648. The communication channels 660-1, 660-2, 660-3 correspond to the NB-IoT, VoLTE, and LTE communication technologies, respectively. The communication channels 646-1, 646-2 correspond to the BLE and Wi-Fi communication technologies, respectively. The communication channel 648 corresponds to the Wi-Fi communication technology.

In the illustrated example of FIG. 5, the LMRs 502, 504, 506 are Wi-Fi/LTE enabled LMRs. Thus, the LMRs 502, 504, 506 are additionally communicably coupled to the LTE towers 406, 410, 408, respectively and the LMRs 502, 504, 506 are additionally communicably coupled to the ISP routers 416, 420, 418, respectively. Therefore, the LMRs 502, 504, 506 may allow exchange of all the data types 154.

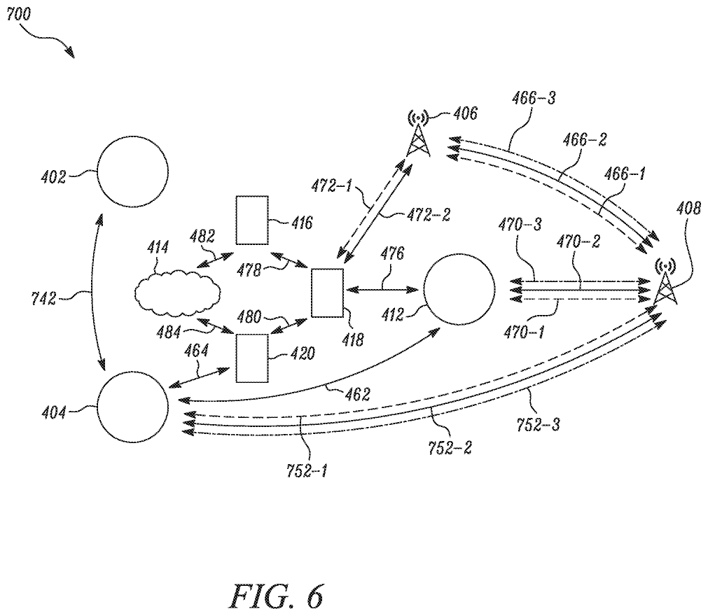

FIG. 6 illustrates an exemplary communication system 700. The communication system 700 is substantially similar to the communication system 400 of FIG. 3. Common components between the communication system 400 and the communication system 700 are referred to by the same reference numerals.

However, in the communication system 700, the article of PPE 402 is not directly communicably coupled to the command center 412. Further, the article of PPE 402 is not communicably coupled to the LTE tower 406 and the ISP router 416.

In order to exchange the one or more data signals 152 (shown in FIG. 1) with the command center 412, the article of PPE 402 may use the article of PPE 404 as an intermediate device. The article of PPE 402 is communicably coupled to the article of PPE 404 via a communication channel 742. Further, the article of PPE 404 is communicably coupled to the LTE tower 408 via communication channels 752-1, 752-2, 752-3. The communication channel 742 corresponds to the Wi-Fi Direct communication technology. The communication channels 752-1, 752-2, 752-3 correspond to the LTE, VoLTE, and NB-IoT communication technologies, respectively.

Therefore, the article of PPE 402 may exchange the one or more data signals 152 with the command center 412 by transmitting the one or more data signals 152 to the article of PPE 404. The article of PPE 404 may further transmit the one or more data signals 152 to the command center 412 via the communication channel 462. In cases the communication channel 462 is unavailable, the article of PPE 404 may transmit the one or more data signals 152 to the command center 412 via the ISP routers 420, 418 or the LTE tower 408.

Referring to FIGS. 1 and 3-6, the communication systems 90, 400, 500, 600, 700 may have an increased likelihood of a successful transmission of the one or more data signals 152 to the intended recipient(s), i.e., the final external devices.

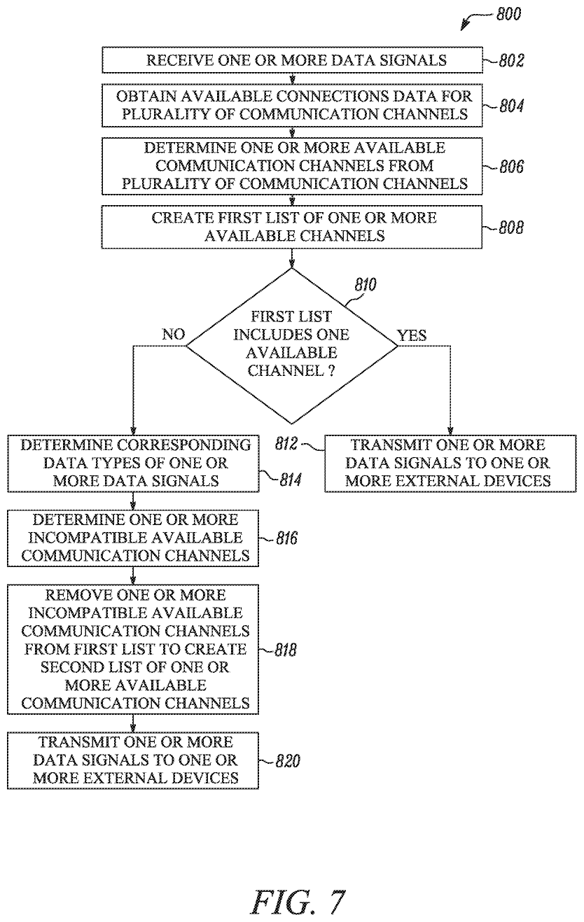

FIG. 7 illustrates a flowchart depicting a computer implemented method 800 of communication, according to an embodiment of the present disclosure. In some embodiments, the method 800 may be implemented by the controller 108 of the article 100 of FIG. 1. In some embodiments, the method 800 may be implemented by the second controllers 268 of the plurality of external devices 112. In some embodiments, a computer program product includes a computer readable medium having computer readable code embodied therein. Further, the computer readable code is configured such that, on execution by a suitable computer or processing unit, the computer or processing unit is caused to perform the computer implemented method 800. The method 800 is described with reference to FIGS. 1 and 7.

At step 802, the method 800 includes receiving the one or more data signals 152. The one or more data signals 152 have the corresponding data types.

At step 804, the method 800 includes obtaining the available connections data 174 for the plurality of communication channels 104 based on the signal strength 176 of each of the plurality of communication channels 104.

At step 806, the method 800 further includes determining the one or more available communication channels from the plurality of communication channels 104 based on the available connections data 174.

At step 808, the method 800 further includes creating a first list of the one or more available communication channels.

At step 810, the method 800 further includes determining if the first list of the one or more available communication channels includes one available communication channel. If the first list of the one or more available communication channels includes one available communication channel, the method 800 moves to the step 812. For example, the first list may include the communication channel 104-1, if only the communication channel 104-1 is available to transmit the one or more data signals 152.

At step 812, the method 800 includes transmitting the one or more data signals 152 to the one or more external devices over the one available communication channel. For example, the one or more data signals 152 to the one or more external devices over the communication channel 104-1.

If the first list of the one or more available communication channels includes more than one available communication channel, the method 800 moves from step 810 to step 814. For example, the first list may include the communication channels 104-1, 104-2, 104-3, 104-4, if the communication channels 104-1, 104-2, 104-3, 104-4 are available to transmit the one or more data signals 152.

At step 814, the method 800 includes if the first list of the one or more available communication channels includes the more than one available communication channel, determining the corresponding data types of the one or more data signals 152 by comparing the one or more data signals 152 with the plurality of data types 154 stored in the memory 106.

At step 816, the method 800 further includes determining one or more incompatible available communication channels from the first list of the one or more available communication channels based on the corresponding data types of the one or more data signals 152. The one or more incompatible available communication channels are not suitable for transmitting the corresponding data types of the one or more data signals 152.

At step 818, the method 800 further includes removing the one or more incompatible available communication channels from the first list of the one or more available communication channels to create a second list of one or more available communication channels. For example, the second list may include the communication channels 104-1, 104-2, 104-3, if the communication channel 104-4 is not suitable for transmitting the corresponding data types of the one or more data signals 152.

At step 820, the method 800 includes transmitting the one or more data signals 152 to the one or more external devices over the one or more available communication channels from the second list. For example, the one or more data signals 152 may be transmitted to the one or more external devices over the one or more available communication channels 104-1, 104-2, 104-3 from the second list.

In some embodiments, if the second list of the one or more available communication channels include more than one available communication channel, the method 800 further includes obtaining the external connections data 280 from each of the one or more external devices. The external connections data 280 is indicative of communication channels available to receive the one or more data signals 152.

In some embodiments, if the second list of the one or more available communication channels includes more than one available communication channel, the method 800 further includes determining one or more unavailable external communication channels from the second list of the one or more available communication channels based on the external connections data. The one or more unavailable external communication channels are not available to receive the one or more data signals 152.

In some embodiments, if the second list of the one or more available communication channels includes more than one available communication channel, the method 800 further includes removing the one or more unavailable external communication channels from the second list of the one or more available communication channels to create a third list of one or more available communication channels.

In some embodiments, if the third list of the one or more available communication channels includes one available communication channel, the method 800 further includes transmitting the one or more data signals 152 to the one or more external devices over the one available communication channel from the third list. For example, the third list may include the communication channel 104-1 if the communication channels 104-2, 104-3 are not available to receive the one or more data signals 152. The one or more data signals 152 may be transmitted to the one or more external devices over the one available communication channel 104-1 from the third list.

In some embodiments, if the third list of the one or more available communication channels includes more than one available communication channel, the method 800 further includes obtaining the one or more user channel preferences 120 corresponding to the one or more available communication channels in the third list. In some embodiments, if the third list of the one or more available communication channels includes more than one available communication channel, the method 800 further includes selecting a first available communication channel from the third list of the one or more available communication channels. In some embodiments, the first available communication channel has a higher user channel preference than the other available communication channels in the third list.

In some embodiments, the method 800 further includes transmitting the one or more data signals 152 to the one or more external devices over the first available communication channel.

For example, the third list may include the communication channels 104-1, 104-2, if the communication channel 104-3 is not available to receive the one or more data signals 152. Further, the communication channel 104-1 may have a higher user channel preference than the communication channel 104-2. The one or more data signals 152 may be transmitted to the one or more external devices over the communication channel 104-1.

In some embodiments, the method 800 further includes determining if the first available communication channel from the third list of the one or more available communication channels is currently transmitting priority data signals having the data type 154 having a priority level greater than the priority levels of the corresponding data types of the one or more data signals 152.

In some embodiments, the method 800 further includes selecting a second available communication channel from the third list of the one or more available communication channels and transmitting the one or more data signals 152 to the one or more external devices over the second available communication channel. In some embodiments, the second available communication channel has a lower user channel preference than the first available communication channel and a higher user channel preference than the remaining available communication channels in the third list.

For example, the communication channel 104-1 having the higher user channel preference than the communication channel 104-2 may be currently transmitting priority data signals having the data type 154 having a priority level greater than the priority levels of the corresponding data types of the one or more data signals 152. The one or more data signals 152 may be transmitted to the one or more external devices over the communication channel 104-2.

The method 800 may improve a probability of a successful transmission of the one or more data signals 152 to the intended recipient(s) of the one or more data signals 152, for example, the one or more external devices. Further, the method 800 may optimize the transmission of the one or more data signals 152 to the intended recipient(s) of the one or more data signals 152.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below, or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components, or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. An article of personal protective equipment (PPE), comprising:
a plurality of communication circuits corresponding to a plurality of communication channels;
a memory configured to store a plurality of data types;
a controller communicably coupled to the plurality of communication circuits and the memory, the controller configured to:
receive one or more data signals, the one or more data signals having corresponding data types from the plurality of data types;
determine a signal strength of each of the plurality of communication channels;
generate available connections data for the plurality of communication channels based on the signal strength of each of the plurality of communication channels;
determine the corresponding data types of the one or more data signals by comparing the one or more data signals with the plurality of data types stored in the memory;
determine one or more available communication channels from the plurality of communication channels based on the available connections data, wherein the one or more available communication channels are available to transmit the one or more data signals;
select at least one available communication channel from the one or more available communication channels based on at least the corresponding data types of the one or more data signals; and
select at least one communication circuit from the plurality of communication circuits corresponding to the at least one available communication channel, such that the at least one communication circuit receives the one or more data signals and transmits the one or more data signals to one or more external devices over the at least one available communication channel.

2. The article of claim 1, wherein the plurality of data types comprises at least one of a video-data type indicative of video data, an audio-data type indicative of audio data, a text-data type indicative of text data, a configuration-data type indicative of configuration data, and a critical-data type indicative of critical data, and wherein the critical data comprises at least one of personal alarm safety system (PASS) data, location data, telemetry data, and the available connections data.

3. The article of claim 2, wherein the memory is further configured to store a plurality of priority levels corresponding to the plurality of data types, wherein the plurality of priority levels comprises first, second, third, fourth, and fifth priority levels corresponding to the critical-data type, the text-data type, the configuration-data type, the audio-data type, and the video-data type, and wherein:
the first priority level of the critical-data type is greater than the second priority level of the text-data type;
the second priority level of the text-data type is greater than the third priority level of the configuration-data type;
the third priority level of the configuration-data type is greater than the fourth priority level of the audio-data type; and
the fourth priority level of the audio-data type is greater than the fifth priority level of the video-data type.

4. The article of claim 3, wherein the controller is further configured to:
determine the priority levels of the corresponding data types of the one or more data signals by comparing the corresponding data types with the plurality of priority levels stored in the memory; and
select the at least one available communication channel from the one or more available communication channels based further on the priority levels of the corresponding data types of the one or more data signals.

5. The article of claim 2, wherein the memory is further configured to store a plurality of priority levels corresponding to the plurality of data types, wherein the plurality of priority levels comprises first, second, third, fourth, and fifth priority levels, wherein the controller is configured to assign the first, second, third, fourth, and fifth priority levels to any of the critical-data type, the text-data type, the configuration-data type, the audio-data type, and the video-data type, and wherein:
the first priority level is greater than the second priority level;
the second priority level is greater than the third priority level;
the third priority level is greater than the fourth priority level; and
the fifth priority level is greater than the fourth priority level.

6. The article of claim 1, wherein at least one communication channel from the plurality of communication channels is configured to transmit two or more data types from the plurality of data types.

7. The article of claim 3, wherein:
the one or more data signals comprise first and second data signals having corresponding first and second data types;
the priority level of the first data type is greater than the priority level of the second data type;
the at least one available communication channel comprises one available communication channel configured to transmit both the first and second data types; and
the controller is further configured to select a communication circuit from the plurality of communication circuits corresponding to the one available communication channel, such that the communication circuit receives the first and second data signals and transmits the first data signal to the one or more external devices over the one available communication channel prior to transmitting the second data signal to the one or more external devices over the one available communication channel.

8-15. (canceled)

16. A communication system comprising:
an article of PPE, the article of PPE comprising:
a plurality of first communication circuits corresponding to a plurality of communication channels;
a first memory configured to store a plurality of data types; and
a first controller communicably coupled to the plurality of first communication circuits and the first memory; and
a plurality of external devices remote from the article of PPE, each of the plurality of external devices comprising at least one second communication circuit communicably coupled to at least one of the plurality of first communication circuits via the corresponding communication channel;
wherein the first controller is configured to:
receive one or more data signals, the one or more data signals having corresponding data types from the plurality of data types;
determine a signal strength of each of the plurality of communication channels;
generate available connections data for the plurality of communication channels based on the signal strength of each of the plurality of communication channels;
determine the corresponding data types of the one or more data signals by comparing the one or more data signals with the plurality of data types stored in the first memory;
determine one or more available communication channels from the plurality of communication channels based on the available connections data, wherein the one or more available communication channels are available to transmit the one or more data signals;
select at least one available communication channel from the one or more available communication channels based on at least the corresponding data types of the one or more data signals; and
select at least one first communication circuit from the plurality of first communication circuits corresponding to the at least one available communication channel, such that the at least one first communication circuit receives the one or more data signals and transmits the one or more data signals to one or more external devices from the plurality of external devices over the at least one available communication channel.

17. (canceled)

18. The communication system of claim 16, wherein the plurality of data types comprises at least one of a video-data type indicative of video data, an audio-data type indicative of audio data, a text-data type indicative of text data, a configuration-data type indicative of configuration data, and a critical-data type indicative of critical data, and wherein the critical data comprises at least one of personal alarm safety system (PASS) data, location data, telemetry data, and the available connections data.

19-25. (canceled)

26. The communication system of claim 16, wherein the plurality of first communication circuits corresponds to a plurality of communication technologies, and wherein the plurality of communication technologies comprises at least one of a long range (LoRa) network communication technology, a Bluetooth low energy (BLE) communication technology, a Wi-Fi communication technology, a WiMax communication technology, a cellular communication technology, a wide area network (WAN) communication technology, a Narrow Band-Internet of Things (NB-IoT) communication technology, a Digital enhanced cordless telecommunications (DECT) communication technology, a Radio frequency (RF) communication technology, a Wi-Fi direct communication technology, a Long-Term Evolution (LTE) communication technology, a Voice over Long Term Evolution (VoLTE) communication technology, a Land Mobile Radio (LMR) communication technology, an ultra-wideband (UWB) communication technology, and a custom communication technology.

27. The communication system of claim 26, wherein the first memory is further configured to store a predetermined hierarchy of the plurality of communication technologies, and wherein the first controller is configured to select the at least one available communication channel from the one or more available communication channels based on the predetermined hierarchy of the plurality of communication technologies.

28. The communication system of claim 16, wherein the plurality of external devices comprises one or more final external devices and one or more intermediate external devices, wherein the one or more external devices comprise the one or more final external devices or the one or more intermediate devices, wherein the one or more data signals are intended to be received by the one or more final external devices, and wherein the one or more intermediate external devices receive and transmit the one or more data signals to the one or more final external devices.

29. The communication system of claim 28, wherein the one or more final external devices comprises at least one of one or more articles of PPE and one or more remote servers, and wherein the one or more intermediate external devices comprise at least one of an LTE tower, a cloud server, and a land mobile radio.

30. The communication system of claim 27, wherein the plurality of external devices comprises corresponding plurality of device identifiers, wherein the first memory is further configured to store the corresponding plurality of device identifiers of the plurality of external devices, wherein the first controller is further configured to select some of the external devices from the plurality of external devices based on the plurality of device identifiers of the plurality of external devices, and wherein the some of the external devices comprise the one or more external devices.

31. The communication system of claim 30, wherein the first controller is further configured to generate and store a network data indicative of the selected some of the external devices from the plurality of external devices in the first memory.

32. The communication system of claim 31 further comprising a common cloud server communicably coupled to each of the article of PPE and the plurality of external devices, wherein the common cloud server comprises a cloud memory, and wherein the first controller is further configured to transmit the network data to the common cloud server, and wherein the cloud memory is configured to store the network data.

33. (canceled)

34. The communication system of claim 28, wherein each of the one or more data signals comprises a plurality of data packets, wherein each data packet comprises a packet structure comprising one or more recipient device identifiers, a source device identifier, one or more intermediate device identifiers, a packet serial number, the data type, a payload, and a cyclic redundancy check (CRC), and wherein the one or more recipient device identifiers are indicative of device identifiers of the one or more final external devices, the source device identifier is indicative of a device identifier of the article of PPE, and the one or more intermediate device identifiers are indicative of device identifiers of the one or more intermediate devices.

35-36. (canceled)

37. The communication system of claim 28, wherein each of the one or more external devices comprises a second controller, and wherein the one or more final external devices from the one or more external devices further comprises a display communicably coupled to the second controller, and wherein upon receipt of the one or more data signals from the article of PPE, the second controller of each of the one or more final external devices is configured to display at least one data corresponding to at least one of the one or more data signals on the display.

38. (canceled)

39. The communication system of claim 26, wherein the first controller is further configured to determine a relative distance between the article of PPE and some of the plurality of external devices comprising the at least one second communication circuit corresponding to the ultra-wideband (UWB) communication technology.

40. A computer-implemented method of communication, comprising:
receiving one or more data signals, the one or more data signals having corresponding data types;
obtaining available connections data for a plurality of communication channels based on a signal strength of each of the plurality of communication channels;
determining one or more available communication channels from the plurality of communication channels based on the available connections data, wherein the one or more available communication channels are available to transmit the one or more data signals;
creating a first list of the one or more available communication channels;
if the first list of the one or more available communication channels comprises one available communication channel, transmitting the one or more data signals to one or more external devices over the one available communication channel; and
if the first list of the one or more available communication channels comprises more than one available communication channel:
determining the corresponding data types of the one or more data signals by comparing the one or more data signals with a plurality of data types stored in a memory;
determining one or more incompatible available communication channels from the first list of the one or more available communication channels based on the corresponding data types of the one or more data signals, wherein the one or more incompatible available communication channels are not suitable for transmitting the corresponding data types of the one or more data signals;
removing the one or more incompatible available communication channels from the first list of the one or more available communication channels to create a second list of one or more available communication channels; and
transmitting the one or more data signals to the one or more external devices over the one or more available communication channels from the second list.

41-45. (canceled)
